(19) United States
(12) Patent Application Publication
(10) Pub. No.: US 2006/0271490 A1
(43) Pub. Date: Nov. 30, 2006

(54) Method of counteracting copying of digital information

(76) Inventor: Antonius Adrianus Cornelis Maria Kalker, Mountain View (NL)

Correspondence Address: PHILIPS INTELLECTUAL PROPERTY & STANDARDS, P.O. BOX 3001, BRIARCLIFF MANOR, NY, 10510, US

(21) Appl. No.: 10/568,369

(22) PCT Filed: Aug. 4, 2004
(86) PCT No.: PCT/IB04/51385

§ 371 Date: Feb. 14, 2006

(30) Foreign Application Priority Data
Aug. 18, 2003 (EP) 03102568.7

(51) Int. Cl. G06Q 99/00

(52) U.S. Cl. 705/57

(57) ABSTRACT

There is provided a method of counteracting copying of digital information comprising the steps of: (a) providing a system (10) comprising at least one content provider (40), at least one consumer having one or more devices (50) for replaying digital information, a first distribution arrangement (30) for distributing authorized copies of said digital information from said at least one content provider (40) to said at least one consumer, and a second distribution arrangement (20) susceptible to distributing unauthorized copies of said digital information from said at least one content provider (40) to said atleast one consumer, (b) arranging for said at least one content provider (40) tobe susceptible to providing authorized copies of said digital information to said at least one customer via the first distribution arrangement (30); (c) arranging for distribution via the second distribution arrangement (20) of copies of said digital information from said at least one content provider (40) wherein at least a portion of said digital information is watermarked; and (d) arranging for said one or more devices (50) to include a watermark detection arrangement (65, 70) operable to identify the digital information presented thereto which has been watermarked, said detection arrangement (65, 70) being susceptible to hindering replay of the digital information which is watermarked. The second distribution arrangement (20) is for example the Darknet.

The present invention relates to methods of counteracting copying of digital information; in particular, but not exclusively, the invention relates to a method of counteracting copying in the Darknet of digital information such as music and video files which are susceptible to being retailed to consumers through conventional distribution networks such as bona fide shops, music stores and postal distributors. Moreover, the present invention also relates to systems suitable for use in implementing the aforementioned methods.

In the context of the present invention, reference will be made to “Darknet”. The Darknet is defined as a collection of networks and technologies used to share digital information, also known as digital content. Moreover, the Darknet is not a separate physical network but a software application and software protocol layer riding on existing communication networks, for example the Internet. Examples of the Darknet include peer-to-peer file sharing, CD and DVD copying, and key and/or password sharing on e-mail and newsgroups. In recent years, there have been vast increases in the Darknet's aggregate bandwidth, reliability, usability, size of shared library and availability of search engines thereon.

In the past, most items of value were physical objects. Patent laws and economies of scale when manufacturing meant that small scale copying of physical objects was usually uneconomical, and large-scale copying was stoppable using policemen and courts where infringement of intellectual property rights occurred.

In contradistinction, in recent times, items of value are increasingly less tangible; often they are merely data bits and/or bytes of digital information, or can be accurately represented as bits and/or bytes. The widespread deployment of packet-switched networks and advances in computer and codec technologies has made it feasible, and even attractive, to deliver items of value in digital form over the Internet. The Internet, amongst other networks, provides a considerable opportunity for low-cost delivery of personalized, high-quality content. A contemporary challenge is that such content is susceptible with relative ease to being distributed illegally. Copyright laws govern the legality of copying and distributing such content, but such laws are becoming increasingly ineffective as computers and high-speed networks become increasingly available world-wide.

Copying and distribution of digital information of value, such information being also referred as data objects, over the Darknet arises when three conditions are satisfied:
(a) any widely distributed data object will be available to a fraction of network users in a form that permits copying;
(b) network users will copy data objects if it is possible and interesting to do so; and
(c) network users are connected by high-bandwidth channels capable of quickly communicating the data objects.

The Darknet is thus a distribution network that emerges from the injection of data objects according to condition (a) and the distribution of data objects arises according to conditions (b) and (c).

More recently, with regard to audio recordings, for example as sold on CD format and similar media, a device has recently become available with a proprietary name “Ripflash”. The device is a gadget retailing at around $179. The gadget is operable to plug into audio replaying equipment, for example CD players, and receive therefrom, for example, analogue signals, for example as provided to drive loud-speakers, and to digitize these signals to generate corresponding digital audio files. As these files are not encrypted, they are susceptible to being freely distributed on the Darknet. The manufacturer of the gadget is not regarded as having transgressed any laws in manufacturing and selling the gadget as it has many legitimate uses, for example as a simple dictation device when coupled to a microphone.

In the past couple of years, major music and film recording companies have seen their profits eroded by unauthorized copies of audio and video recordings being distributed on the Darknet, for example via parts of the Internet. Such unauthorized distribution arises from one or more of central network servers or in a peer-to-peer decentralized manner of distribution.

Unauthorized distribution of audio and/or video data objects is reported to be a major concern to record labels, for example a part of Sony Corporation concerned with engaging music artists, recording their music and subsequently manufacturing CD's and/or similar data carriers having the music pre-recorded thereon. It is reported for the United States that “units shipped”, namely pre-recorded CD's dispatched to record stores/shops or retailed directly to consumers fell by more than 6% in year 2001, and by 6% to 10% in year 2002. Such falls in sales are impacting record labels hard. For example, such record labels are laying off employees, abandoning artists, reducing budgets for artists' tours and videos, and combing their back catalogues for reissues of earlier recording that cost relatively little investment to produce and release for sale.

The use of encryption, private/public keys and other related barriers to unauthorized copying and distribution of data objects of value has been earlier proposed. In practice, it is found that computer hackers and such individuals are capable of circumventing such barriers in most cases. Once the barriers are broken, subsequent dissemination of associated data objects can occur relatively rapidly over the Darknet, for example in a matter of days or even hours. Moreover, such barrier-breaking and subsequent unauthorized distribution of data objects can occur where an original hacker of the data objects remains substantially anonymous, thereby evading prosecution. Moreover, especially where peer-to-peer distribution occurs, identification of a distributor of the hacked data objects is often virtually impossible. For these reasons, conventional methods of identifying and preventing copyright infringement, for example courts of law, are ineffective on account of their stow reaction times and associated laborious procedures.

Having appreciated that the aforementioned barriers are substantially circumventable and that purchasers of equipment are more inclined to purchase equipment capable of replaying both hacked and original authorized version of data objects from data carrying media such as CD's and DVD's, the record labels have appreciated that other approaches to combat counterfeiting and hacking of data objects are required.

For example, in a United States patent application no. US 2002/0082999, there is described a method of preventing reduction of sales amount of records due to a digital music file being illegally distributed through a communication network. The method comprises the steps of:
(a) producing an advertising digital music file by deteriorating or damaging a sound quality of an original music file of a record of a co-operating record corporation; and
(b) distributing the advertising digital music file through the communication network.

The method results in a digital music file with lower sound quality for publicity, and distributing it over the network before a corresponding formal record is sold, thereby reducing a distribution of the illegal digital music file with the same quality as the original music file on the network. However, the method relies on one or more customers liking the music and yet disliking the quality of the recording sufficiently to want to pay a full price for an original music file. Moreover, once a few original copies of the music file are sold, their content will subsequently be rapidly distributed via the Darknet.

In a publication by MicroSoft Corporation with title “The Darknet and the Future of Content Distribution” by Peter Biddle, Paul England, Marcus Peindo and Bryan Willman, it is reported that the use of watermarks in data objects is known. Such watermarks are arranged to be substantially imperceptible on replay where the data objects are music files and/or video files. However, such watermarks added to data objects are susceptible to electronic detection. A plethora of digital watermarking schemes are already known for image content and computer programs. Replaying apparatus is susceptible to being arranged to operate with watermarked original data objects. However, building a watermark detection system into apparatus renders it less attractive to users than corresponding apparatus without watermark detection. Thus, such an approach is likely to fail commercially unless mandated by international legislation.

Even if watermarking systems were mandated, such an approach is likely to fail on account of various technical inadequacies.

A first inadequacy concerns the robustness of an embedded layer carrying the watermark to tampering. Moreover, most watermarks are susceptible to being removed by simple data transformations potentially executable by hackers. Watermarks can be arranged to pervade a relatively large proportion of data objects but then require corresponding data object replaying apparatus to search a relatively larger data area for purposes of detecting the watermarks resulting in longer watermark searching times which become untenable.

A second inadequacy concerns key management. Most contemporary watermarking schemes require widely deployed cryptographic keys. Standard watermarking schemes are based on conventional cryptographic principles of a public algorithm (detector) and secret keys (marker). Most watermarking schemes use a shared-key between marker and detector. In practice, this means that all watermark detectors need to be provided with a private key, and typically share a private key. It is difficult for such private keys to remain secret in an adversarial environment including experienced hackers. Once such private keys are compromised, the Darknet is able to propagate them efficiently rendering such watermark protection ineffective.

A third inadequacy concerns watermark detectors on open computing devices being implemented in software. Such implementation is easily circumvented, namely merely replacing an item of software. Placing detectors in hardware, for example in existing computing equipment, would be prohibitively expensive and impractical and is thus untenable.

There is evidence that the Darknet will continue to exist in the future to provide a low cost, high-quality service to a large group of customers. Such evidence means that, in many markets, the Darknet will continue to be a competitor to legal commerce.

Despite the short-comings of previous attempts to counteract copying of digital information, for example data objects, for example by way of:
(i) encryption;
(ii) distribution of degraded copies as described in United States patent no. US 2002/0082999; and
(iii) watermarking,
the inventor has appreciated that an alternative approach to counteracting copying of digital information on the Darknet is required. The inventor has devised such a method according to the present invention.

A first object of the present invention is to provide a more effective method of counteracting copying of digital information, for example music and/or image data files, over publicly-accessible networks, for example the Darknet.

A second object of the present invention is to provide a more effective method of counteracting copying of digital information by including watermark content in the information.

According to a first aspect of the present invention, there is provided a method of counteracting copying of digital information, the method comprising the steps of:
(a) providing a system comprising at least one content provider, at least one consumer having one or more devices for replaying digital information, first distributing means for distributing authorized copies of said digital information from said at least one content provider to said at least one consumer, and second distributing means susceptible to distributing unauthorized copies of said digital information from said at least one content provider to said at least one consumer;
(b) arranging for said at least one content provider to be susceptible to providing authorized copies of said digital information to said at least one customer via the first distributing means;
(c) arranging for distribution via the second distributing means of copies of said digital information from said at least one content provider wherein at least a portion of said digital information distributed via the second distributing means is watermarked; and
(d) arranging for said one or more devices to include watermark detecting means operable to identify the digital information presented thereto which has been watermarked, said detecting means being susceptible to hindering replay of the digital information which is watermarked.

The invention is of advantage in that it is capable of at least partially frustrating distribution of the digital information via the second distributing means.

The at least one content provider is, for example, at least one record label. Preferably, the authorized copies of said digital information are substantially devoid of watermarks detectable to the detector. In other words, the authorized copies are susceptible to including other types of watermarks which are not detectable to said one or more devices.

Preferably, the portion of the digital information which is watermarked is covertly watermarked. Such covert watermarking is susceptible to frustrating the second distributing means from filtering digital information being transmitted there through which is watermarked to prevent replay of the digital information.

In order to render the method more effective in practice to reduce pirate copying, the watermark detecting means is preferably a legislated requirement for said one or more devices.

Beneficially, when applying the method, the second distributing means includes the Darknet.

Preferably, the first distributing means comprises at least one of: at least part of the Internet, stores/retailers, postal delivery services and library facilities. Such a first distributing means is of advantage in that it is capable of ensuring revenues derived from sales of the digital information passing back to said at least one content provider, for example at least one record label.

Preferably, the authorized copies of said digital information are conveyed on physical data carriers. More preferably, the data carriers are at least one of CD's and DVD's.

Preferably, more than 20% of the digital information provided from said at least one content provider, for example at least one record label, for distribution via the second distributing means is subject to watermarking. More preferably, more than 50% of the digital information provided from said at least one content provider for distribution via the second distributing means is subject to watermarking. Most preferably, more than 80% of the digital information provided from said at least one content provider for distribution via the second distributing means is subject to watermarking.

Preferably, to further frustrate one or more customers who seek to acquire the digital information via the second distributing means, the one or more devices are randomly operable to hinder replay of digital information received thereat when said digital information is at least partially watermarked.

According to a second aspect of the present invention, there is provided a system for counteracting copying of digital information, the system comprising:
(a) at least one content provider, for example at least one record label;
(b) at least one consumer having one or more devices for replaying digital information;
(c) first distributing means for distributing authorized copies of said digital information from said at least one content provider to said at least one consumer; and
(d) second distributing means susceptible to distributing copies of said digital information from said at least one content provider to said at least one consumer, the system being arranged such that:
(e) said at least one content provider is susceptible to providing authorized copies of said digital information to said at least one customer via the first distributing means;
(f) said second distributing means is susceptible to distributing copies of said digital information wherein at least a portion of said digital information distributed by the second distributing means is watermarked; and
(g) said one or more devices include watermark detecting means operable to identify the digital information presented thereto which has been watermarked, said detecting means being susceptible to hindering replay of the digital information which is watermarked.

The system is capable of addressing at least one of the objects of the invention.

Preferably, the authorized copies of said digital information are substantially devoid of watermarks detectable to the detector.

Preferably, the portion of the digital information which is watermarked is covertly watermarked.

Preferably, the watermark detecting means is a legislated requirement for said one or more devices.

Beneficially, the second distributing means includes the Darknet.

Preferably, the first distributing means comprises at least one of: at least part of the Internet, stores/retailers, postal delivery services and library facilities.

Preferably, the authorized copies of said digital information are conveyed on physical data carriers. More preferably, the data carriers are at least one of CD's and DVD's.

Preferably, more than 20% of the digital information provided from said at least one content provider, for example at least one record label, for distribution via the second distributing means is subject to watermarking. More preferably, more than 50% of the digital information provided from said at least one content provider for distribution via the second distributing means is subject to watermarking. Most preferably, more than 80% of the digital information provided from said at least one content provider for distribution via the second distributing means is subject to watermarking.

Preferably, the one or more devices are randomly operable to hinder replay of digital information received thereat when said digital information is at least partially watermarked.

It will be appreciated that features of the invention are susceptible to being combined in any combination without departing from the scope of the invention.

Embodiments of the invention will now be described, by way of example only, with reference to the following diagram wherein

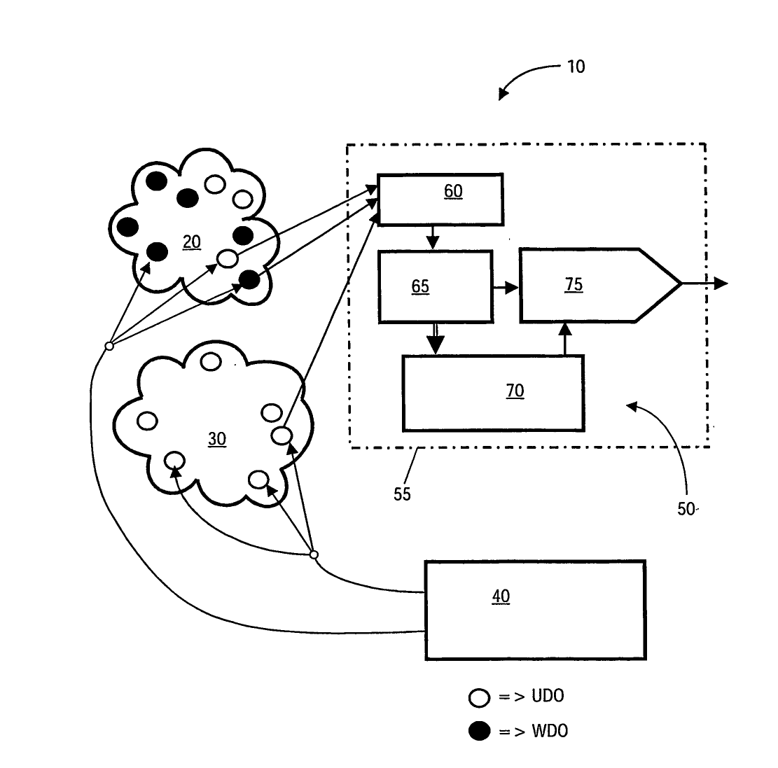

FIG. 1 is a schematic diagram of a system operable according to the method of the invention.

The inventor has appreciated that unauthorized copying and distribution of digital information, for example data objects corresponding to audio and/or video content, is most effectively tackled by a synergistic combination of:
(a) watermarking at least some copies of data objects distributed on the Darknet to frustrate unauthorized copying; and
(b) providing replaying devices to customers, the devices being capable of detecting watermark content in data objects, being capable of replaying data objects devoid of watermark content, and having features for hindering replay of data objects that have been watermarked.

Several benefits derive from the method of the invention. Namely, the devices are operable to replay all data objects in a format compatible with the devices where the data objects are devoid of watermarks detectable to the devices. Thus, the devices are capable of providing backward compatibility with earlier data objects, for example a collection of CD's accumulated over several past years. Such backward compatibility is important to render the device acceptable to customers in preference to alternative products devoid of watermark detection features.

Watermarks inserted into data objects distributed on the Darknet are preferably substantially undetectable to ordinary users of the Darknet, namely covert thereto.

The method of the invention will now be described in more detail with reference to FIG. 1.

In FIG. 1, there is provided a schematic diagram of a data object distribution system indicated generally by 10. The system 10 comprises the Darknet 20 and authorized retail channels 30. The system 10 also incorporates one or more record labels, for example a record label 40. The record label 40 is a manufacturer or supplier of pre-recorded data carriers, for example CD's and DVD's. Alternatively, or additionally, the record label 40 is susceptible to being a general data content provider. Thus, each data carrier has pre-recorded thereon one or more data objects legitimately provided by the record label 40. The system 10 further includes one or more customer replay devices, for example a customer device indicated generally by 50 and included within a dotted line 55. The device 50 includes a drive 60 for accessing one or more data carriers, for example the drive 60 is an optical disc unit susceptible to receiving and optically interrogating one or more of CD's and DVD's. The device 50 further comprises a buffer 65, a watermark detector 70 and a decoder 75. The drive 60 is coupled to the buffer 65 for providing data thereto read from data carriers provided to the drive 60. Moreover, a first data output from the buffer 65 is coupled to a data decoding input of the decoder 75, the decoder being susceptible to decoding data objects presented thereto to generate therefrom corresponding audio and/or video program material. Furthermore, a second data output from the buffer 65 is coupled to the detector 70 for providing data thereto for watermark analysis. The buffer 65 is required because watermark content is, for example in audio data objects, distributed over significant proportions of the data object passed through the buffer 65 in operation. The data buffer 65 is also capable of providing the device 50 with mechanical anti-shock robustness characteristics.

Operation of the system 10 will now be described with reference to FIG. 1.

The record label 40 generates data objects which are either watermarked data objects (WDO) denoted by black circles or non-watermarked data objects (UDO) denoted by white circles.

The record label 40 distributes authorized data objects in the form of UDO on data carriers, for example physical CD's and/or DVD's for retail via post and/or shops/stores, or as data objects, for example for bona fide data object distribution via the Internet in return for payment from consumers to the label 40. Thus, in order to generate revenue, the label 40 distributes the non-watermarked data objects (UDO) via the authorized retail channels 30, for example shop/stores and/or legitimate Internet sales, to one of more of the customers owning one or more devices 50.

Moreover, the label 40 also distributes a mixture of corresponding non-watermarked data objects (UDO) and watermarked data objects (WDO) via the Darknet 20. The logic of distribution via the Darknet 20 is that at least some customers buying legitimately via the authorized retail channels 30 will in any case proceed to distribute unauthorized copies of the non-water data objects (UDO) via the Darknet 20.

Customers having one or more devices 50 in many cases will seek unauthorized copies of data objects via the Darknet 20. Without being aware of whether or not such unauthorized copies of the data objects are watermarked, namely whether the unauthorized copies are WDO or UDO, the customers will download such unauthorized data objects. When the customers attempt to replay the unauthorized copies in their one or more of their devices 50, the buffer 65 therein in combination with the detector 70 therein will prevent the decoder 75 from replaying the unauthorized data object obtained from the Darknet 20 when WDO. However, the buffer 65 therein in combination with the detector 70 therein will allow the decoder 75 to replay unauthorized data objects obtained from the Darknet 20 when UDO.

Preferably, the devices 50 are by virtue of legislation required to include the buffer 65 and its associated detector 70 for hindering replay of WDO's.

The end-result is that the one or more customers will experience that unauthorized copies of data objects obtained via the Darknet 20 are unreliable when replayed whereas authorized copies of corresponding data objects purchased via the authorized retail channels 30 substantially always reliably replay. Consequentially, customers will be inclined to purchase the authorized data objects via the channels 30 to avoid disappointment arising from obtaining unauthorized copies via the Darknet 20.

In order to further confuse customers, their one or more devices 50 beneficially additionally include a random number generator so that the decoder 70, when it detects the presence of watermarked data objects (WDO) randomly allows or hinders replay of the WDO. Thus, frustration associated with apparently-unreliable unauthorized data objects obtained via the Darknet 20 will encourage customers to obtain bona fide authorized copies of such data objects.

On account of the record label 40 distributing numerous copies of UWO and WDO via the Darknet 20, it is not practicable for operators of the Darknet 20 to check all copies of data objects distributed via the Darknet 20 to determined whether or not they include watermark content. It is therefore impractical for operators of the Darknet 20 to rid the Darknet 20 of copies of data objects arranged to frustrate customers.

The proportion of WDO to UDO data objects distributed by the record label 40 on the Darknet 20 is susceptible to being varied depending on a degree of unauthorized copying anticipated. Preferably, more than 20% of the data objects distributed by the record label 40 on the Darknet 20 are WDO. More preferably, more than 50% of the data objects distributed by the label 40 on the Darknet 20 are WDO. Most preferably, more than 80% of the data objects distributed by the label 40 on the Darknet 20 are WDO.

Whereas conventional approaches utilize lack of watermarked content to hinder replay, the present invention is distinguished in that it uses a substantially opposite approach, namely watermark content is susceptible to hindering replay. The inventor has appreciated that such an opposite approach is beneficial after having carefully considered human psychology associated with unauthorized copying, namely hacking and/or pirating, as witnessed in recent years in the Darknet 20.

In the foregoing, it is preferably difficult for a consumer to distinguish between watermarked music and non-watermarked music provided as data content. Only when data is re-played on one or more devices provided with appropriate watermark detection hardware will a difference between watermarked and non-watermarked data content become apparent to the consumer.

It will be appreciated that embodiments of the invention described in the foregoing are susceptible to being modified without departing from the scope of the invention.

In the foregoing, expressions such as “include”, “comprise”, “incorporate”, “contain”, “have”, “has”, “is”, “are” are to be interpreted so as not to exclude there being additional unspecified items and/or components present. Similarly, the singular shall also be construed to refer to the plural and vice versa.

1. A method of counteracting copying of digital information, the method comprising the steps of:
(a) providing a system (10) comprising at least one content provider (40), at least one consumer having one or more devices (50) for replaying digital information, first distributing means (30) for distributing authorized copies of said digital information from said at least one content provider (40) to said at least one consumer, and second distributing means (20) susceptible to distributing unauthorized copies of said digital information from said at least one content provider (40) to said at least one consumer;
(b) arranging for said at least one content provider (40) to be susceptible to providing authorized copies of said digital information to said at least one customer via the first distributing means (30);
(c) arranging for distribution via the second distributing means of copies of said digital information from said at least one content provider (40) wherein at least a portion of said digital information is watermarked; and
(d) arranging for said one or more devices (50) to include watermark detecting means (65, 70) operable to identify the digital information presented thereto which has been watermarked, said detecting means (65, 70) being susceptible to hindering replay of the digital information which is watermarked.

2. A method according to claim 1, wherein the authorized copies of said digital information are substantially devoid of watermarks detectable to the detector (65, 70).

3. A method according to claim 1 or 2, wherein the portion of the digital information which is watermarked is covertly watermarked.

4. A method according to claim 1, 2 or 3, wherein the watermark detecting means (65, 70) is a legislated requirement for said one or more devices (50).

5. A method according to any one of the preceding claims, wherein the second distributing means (20) includes the Darknet (20).

6. A method according to any one of the preceding claims, wherein the first distributing means (30) comprises at least one of: at least part of the Internet, stores/retailers, postal delivery services and library facilities.

7. A method according to any one of the preceding claims, wherein the authorized copies of said digital information are conveyed on physical data carriers.

8. A method according to claim 7, wherein the data carriers are at least one of CD's and DVD's.

9. A method according to any one of the preceding claims, wherein more than 20% of the digital information provided from said at least one content provider (40) for distribution via the second distributing means (20) is subject to watermarking.

10. A method according to claim 9, wherein more than 50% of the digital information provided from said at least one content provider (40) for distribution via the second distributing means (20) is subject to watermarking.

11. A method according to claim 9 or 10, wherein more than 80% of the digital information provided from said at least one content provider (40) for distribution via the second distributing means (20) is subject to watermarking.

12. A method according to any one of the preceding claims, wherein the one or more devices (50) are randomly operable to hinder replay of digital information received thereat when said digital information is at least partially watermarked.

13. A system (10) for counteracting copying of digital information, the system (10) comprising:
(a) at least one content provider (40);
(b) at least one consumer having one or more devices (50) for replaying digital information;
(c) first distributing means (30) for distributing authorized copies of said digital information from said at least one content provider (40) to said at least one consumer; and
(d) second distributing means (20) susceptible to distributing copies of said digital information from said at least one content provider (40) to said at least one consumer, the system (10) being arranged such that:
(e) said at least one content provider (40) is susceptible to providing authorized copies of said digital information to said at least one customer via the first distributing means (30);
(f) said second distributing means (20) is susceptible to distributing copies of said digital information wherein at least a portion of said digital information distributed by the second distributing means (20) is watermarked; and
(g) said one or more devices (50) include watermark detecting means (65, 70) operable to identify the digital information presented thereto which has been watermarked, said detecting means (65, 70) being susceptible to hindering replay of the digital information which is watermarked.

14. A system (10) according to claim 13, wherein the authorized copies of said digital information are substantially devoid of watermarks detectable to the detector (65, 70).

15. A system (10) according to claim 13 or 14, wherein the portion of the digital information which is watermarked is covertly watermarked.

16. A system (10) according to claim 13, 14 or 15, wherein the watermark detecting means (65, 70) is a legislated requirement for said one or more devices (50).

17. A system (10) according to any one of claims 13 to 16, wherein the second distributing means (20) includes the Darknet (20).

18. A system (10) according to any one of claims 13 to 17, wherein the first distributing means (30) comprises at least one of: at least part of the Internet, stores/retailers, postal delivery services and library facilities.

19. A system (10) according to any one of claims 13 to 18, wherein the authorized copies of said digital information are conveyed on physical data carriers.

20. A system (10) according to claim 19, wherein the data carriers are at least one of CD's and DVD's.

21. A system (10) according to any one of claims 13 to 20, wherein more than 20% of the digital information provided from said at least one content provider (40) is subject to watermarking.

22. A system (10) according to claim 21, wherein more than 50% of the digital information provided from said at least one content provider (40) for distribution via the second distributing means (20) is subject to watermarking.

23. A system (10) according to claims 21 or 22, wherein more than 80% of the digital information provided from said at least one content provider (40) for distribution via the second distributing means (20) is subject to watermarking.

24. A system (10) according to any one of claims 13 to 23, wherein the one or more devices (50) are randomly operable to hinder replay of digital information received thereat when said digital information is at least partially watermarked.
